(19) United States
(12) Patent Application Publication
(10) Pub. No.: US 2020/0282602 A1
(43) Pub. Date: Sep. 10, 2020

(54) PREFORM

(71) Applicant: SUNTORY HOLDINGS LIMITED, Osaka (JP)

(72) Inventors: Kenji TSUMORI, Tokyo (JP); Toshiya KOBAYASHI, Tokyo (JP)

(73) Assignee: SUNTORY HOLDINGS LIMITED, Osaka (JP)

(21) Appl. No.: 16/618,199

(22) PCT Filed: May 30, 2017
(86) PCT No.: PCT/JP2017/020089

§ 371 Date: Nov. 29, 2019

(51) Int. Cl. B29B 11/14

(52) U.S. Cl. CPC B29B 11/14

(57) ABSTRACT

A preform for use in molding a bottle by blow molding includes a tubular sprout portion and a bottomed tubular preform body. The preform has a weight ranging from 82 to 90 g. The maximum wall thickness of the preform body ranges from 4.5 to 5.0 mm. The preform has a total length ranging from 165 to 175 mm.

This disclosure relates to a preform for use in molding a bottle by the blow molding technique.

### TECHNICAL FIELD

A resin-made bottle to be filled with e.g. beverage is formed generally by the blow molding technique. Specifically, such resin-made bottle can be obtained by a series of steps illustrated respectively in FIG. 3. Namely, after a preform (parison) 1 in the form of a test tube is heated to an appropriate temperature by a heater 3 (FIG. 3 (a)), this hot preform 1 is set in a mold 4 having a desired shape (FIG. 3 (b)). Then, the preform 1 is stretched in the vertical direction by a stretching rod 5 (FIG. 3 (c)), then, an amount of high-pressure air is blown into the preform 1 to blow it out into a bottle shape (FIG. 3 (d)).

Moreover, if the above-described series of blow molding steps are carried out jointly in synchronism with a subsequent contents filling step for the bottle by a filler, such arrangement will be advantageous as it allows simplification of the plant operation. In such case, it is necessary to carry out the series of blow molding steps and the contents filling step at a same speed. Thus, in order to allow the synchronized operation of the blow molding steps and the contents filling step, the blow molding steps need to be carried out at a high speed.

### SUMMARY OF THE INVENTION

### Problem to be Solved by Invention

However, in the case where the bottle to be molded has a large capacity, the preform needs to be molded into a correspondingly large size by blow molding. This requires increase in the wall thickness of the preform 1, which in turn results in corresponding increase in the weight of the preform 1. Then, a longer time will be needed for heating the preform 1 to the appropriate temperature and blow-molding it. If it is attempted to carry out the above in a short time, as the process is sensitively subjected to such influences as possible irregularity according to the manufacture lot of the preform, etc., difficulty will be encountered in making necessary adjustments in the series of blow molding steps. Therefore, in order to carry out the blow molding steps stably at a same speed as the contents filling step, it will become necessary to e.g. increase the zone for heating, to enlarge the facility relating to the blow molding steps, etc., which all lead to increase in the facility cost disadvantageously.

In view of the above, the principal object of this disclosure is to provide a preform that can be blow-molded and that yet can suppress occurrence of irregularity in the bottle shape after the blow molding process.

### Solution

A preform according to this disclosure, which is for use in molding a bottle by blow molding, comprising:

a tubular sprout portion and a bottomed tubular preform body;

wherein the preform has a weight ranging from 82 to 90 g;

the maximum wall thickness of the preform body ranges from 4.5 to 5.0 mm; and

the preform has a total length ranging from 165 to 175 mm.

With the above-described balance setting among the weight, the wall thickness and the total length provided by this disclosure, even when the bottle to be molded has a large capacity, the preform can be heated in an efficient manner.

According to one preferred embodiment, a joint portion of the preform body to the spout portion comprises a tapered portion whose wall thickness progressively increases as it extends away from the spout portion; and the tapered portion has a straight outer circumferential face and a tapered inner circumferential face.

With the above-described arrangement of forming the outer circumferential face of the joint portion of the preform body to the spout portion straight and forming the inner circumferential face thereof tapered, portions which are to form the neck portion and the shoulder portion after the bottle molding can be lightened easily, and the total weight of the preform can be suppressed correspondingly. Consequently, the wall thickness can be reduced. With this, it becomes possible to heat the preform in an even more efficient manner.

According to one preferred embodiment, the tapered portion has a length ranging from 4 to 12 mm.

By setting the length of the tapered portion to from 4 to 12 mm as provided by the above-described arrangement, the portions which are to form the neck portion and the shoulder portion after the bottle molding can be lightened even more easily.

According to one preferred embodiment, the preform is configured to be used for molding a bottle in which a ratio of a length of a body portion relative to the total length of the bottle ranges from 0.30 to 0.50.

With the preform having such balance of the weight, the wall thickness and the total length as provided by the above-described configuration, it is possible to form a bottle having the ratio ranging from 0.30 to 0.50 of the length of the body portion relative to the total length of the bottle favorably.

### BRIEF DESCRIPTION OF THE DRAWINGS

FIG. 1 is a section view of a preform,

FIG. 2 is a front view showing an example of a bottle molded from a preform relating to an embodiment, and

FIG. 3 is a view illustrating blow molding steps.

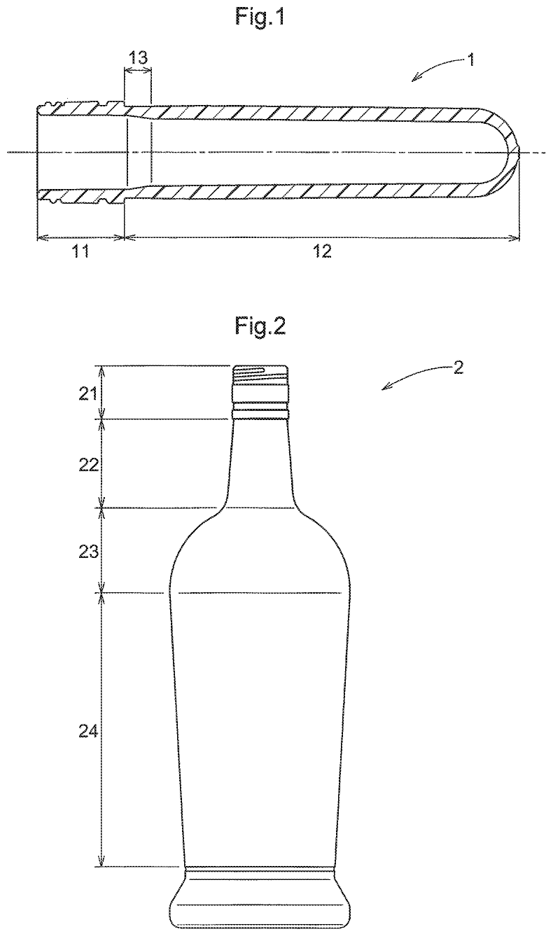

### EMBODIMENT

Next, an embodiment of a preform relating to this disclosure will be explained with reference to the accompanying drawings. A preform 1 relating to the instant embodiment is for use in molding a bottle 2 exemplified by one shown in FIG. 2 by the blow molding technique. The preform 1 as a whole presents a test-tube like shape and is made mainly of a thermosetting resin such as polyethylene, polypropylene, polyethyleneterephthalate, etc.

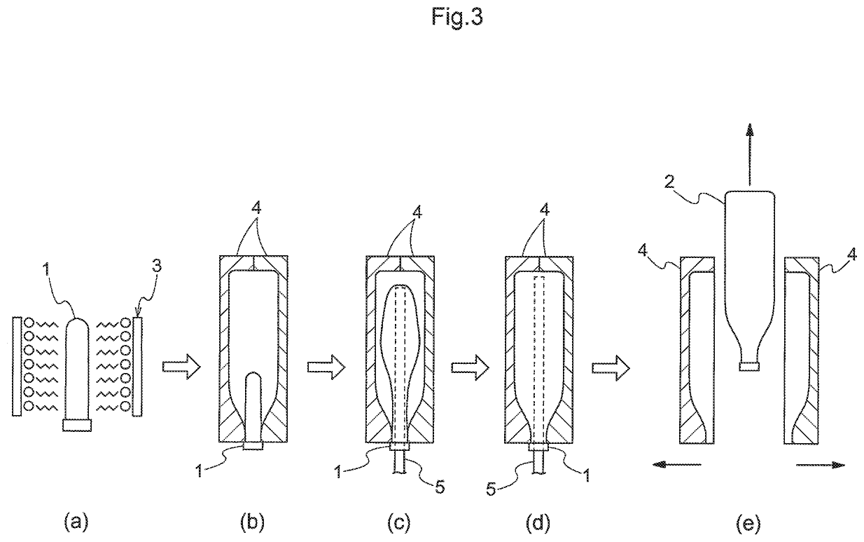

Moreover, as shown in FIG. 3, a bottle 2 having a desired shape can be obtained from this preform 1 by carrying out a series of blow molding steps. Namely, the preform 1 is heated to an appropriate temperature by a heater 3 (FIG. 3 (a)), this hot preform 1 is set in a mold 4 (FIG. 3 (b)). Then, the preform 1 is stretched in the vertical direction by a stretching rod 5 (FIG. 3 (c)), then, an amount of high-pressure air is blown into the preform 1 to blow it out into the shape of the bottle 2 (FIG. 3 (d)) and the bottle 2 after being cooled is removed (FIG. 3 (e)).

In the case where the bottle 2 to be molded has a large capacity, it becomes necessary to blow the preform 1 correspondingly larger. Thus, the weight of the preform 1 needs to be increased correspondingly by e.g. increasing the wall thickness of the preform 1. However, increased weight results in increase in the wall thickness, which in turn leads to necessity of a longer time for heating the preform 1 to an appropriate temperature. To cope with this, the preform 1 relating to the instant embodiment is configured such that the preform 1 can be heated in an efficient manner even when the bottle 2 to be molded has a large capacity. Therefore, with using a standard blow molding device, it is still possible to carry out the above-described series of blow molding steps and the contents filling step in conjunction and synchronism with each other, thus making simplification of the plant operation possible. Next, the preform 1 relating to the instant embodiment will be explained specifically.

The preform 1 relating to the instant embodiment includes a tubular spout portion 11 and a bottomed tubular preform body 12. The preform 1 is configured such that its weight ranges from 82 to 90 g, the maximum wall thickness of the preform body 12 ranges from 4.5 to 5.0 mm, and the total length ranges from 165 to 175 mm. With the above balance setting among the weight, the wall thickness and the total length, even when the bottle to be molded has a large capacity, it is still possible to heat the preform in an efficient manner.

Specifically, the preform 1 can be heated efficiently to the inner side thereof with using a standard blow molding device capable of heating the preform 1 to from 95 to 120° C.

The joint portion of the preform body 12 to the spout portion 11 is constituted of a tapered portion 13 whose wall thickness progressively increases as it extends away from the spout portion 11. In the tapered portion 13, its outer circumferential face is formed straight and its inner circumferential face is tapered. With this arrangement of forming the outer circumferential face of the joint portion of the preform body 12 to the spout portion 11 straight and forming its inner circumferential face tapered, the portion which is to form a neck portion 22 and a shoulder portion (continuous from the neck portion 22 and has a diameter that progressively increases toward the lower side) 23 can be lightened easily, so that the total weight of the preform 1 can be suppressed correspondingly. As a result, the wall thickness can be suppressed, which in turn makes it possible to heat the preform even more efficiently.

Further, the length of the tapered portion 13 is set to range from 4 to 12 mm. With this setting of the length of the tapered portion 13 from 4 to 12 mm, the portion which is to form the neck portion 22 and the shoulder portion 23 after the molding of the bottle 2 can be lightened even more easily.

In addition, with the preform 1 having the above-described balance setting of the weight, the wall thickness and the total length, it is possible to suitably form the bottle 2 having a shape similar to a glass bottle to be used for filling a beverage, e.g. hard liquor such as whisky, wine, etc., therein, such as the one shown in FIG. 2. More particularly, such bottle having a relatively long neck portion continuous from the spout portion (denoted with numeral 21 in the bottle shown in FIG. 2) can be suitably molded which has e.g. an approximately straight body type or a tubular neck portion (denoted with numeral 22 in the case of the bottle shown in FIG. 2) having a diameter progressively increased toward the lower side and the height-wise length of this neck portion is substantially equal to or longer than the height-wise length of the shoulder portion (denoted with numeral 23 in the bottle shown in FIG. 2).

Further, as for some preferred conditions of the bottle to be molded by the preform 1 of the instant embodiment, its capacity ranges from 1.5 to 4.0 liters and more preferably from 1.5 to 3.0 liters, and especially preferably ranges at 1.75-0.10 liters. Further, the ratio of the length of the body portion (denoted with numeral 24 in the bottle shown in FIG. 2) relative to the total length of the bottle ranges preferably from 0.30 to 0.50, more preferably from 0.30 to 0.45 and especially preferably from 0.33 to 0.41. Further, the total length of the bottle ranges preferably from 300 to 400 millimeters.

Incidentally, the shape of the preform 1 of the instant embodiment, the shape/capacity of the resin bottle molded by the preform 1 are not particularly limited. Further, the liquid to be charged and filled in the resin-made bottle is not particularly limited. As some non-limiting examples thereof, drinking water, carbonated beverage, tea, juice, coffee, cocoa, soft drink, alcoholic drink, milk-based drink, or liquid food such as soup, and liquid condiment such as Worcester sauce, soy sauce can be cited.

### INDUSTRIAL APPLICABILITY

The present disclosure can be applicable to a preform for use in molding a bottle to be filled with e.g. a liquid.

### DESCRIPTION OF SIGNS

1: preform
11: spout portion
12: preform body
13: tapered portion
2: bottle

1. A preform for use in molding a bottle by blow molding, comprising:
a tubular sprout portion and a bottomed tubular preform body;
wherein the preform has a weight ranging from 82 to 90 g;
the maximum wall thickness of the preform body ranges from 4.5 to 5.0 mm; and
the preform has a total length ranging from 165 to 175 mm.

2. The preform of claim 1, wherein:
a joint portion of the preform body to the spout portion comprises a tapered portion whose wall thickness progressively increases as it extends away from the spout portion; and
the tapered portion has a straight outer circumferential face and a tapered inner circumferential face.

3. The preform of claim 2, wherein the tapered portion has length ranging from 4 to 12 mm.

4. The preform of claim 1, wherein the preform is configured to be used for molding a bottle in which a ratio of a length of a body portion relative to the total length of the bottle ranges from 0.30 to 0.50.
